(19) United States
(12) Patent Application Publication
(10) Pub. No.: US 2016/0304147 A1
(43) Pub. Date: Oct. 20, 2016

(54) VELOCIPEDE

(71) Applicant: Stefano Mangini, Nole (IT)

(72) Inventor: Stefano Mangini, Nole (IT)

(21) Appl. No.: 15/187,185

(22) Filed: Jun. 20, 2016

Related U.S. Application Data
(63) Continuation-in-part of application No. PCT/IB2014/002847, filed on Dec. 18, 2014.

(30) Foreign Application Priority Data
Dec. 20, 2013 (IT) MI2013A002174

(51) Int. Cl. B62J 1/08; B62K 21/16; B62M 3/08

(52) U.S. Cl. CPC B62J 1/08; B62M 3/08; B62K 21/16; B62J 2001/085

(57) ABSTRACT

A velocipede (1) with front-wheel drive comprising at least one front wheel (4), with the pedal axle coinciding with the front axis of the hub of said front wheel (4), a frame (8b), a fork, at least two saddles/seats (2, 3), a transmission mechanism of the movement, a handlebar (7) and a rear wheel (5), wherein said velocipede (1) having the trim of the center of gravity of at least one user is adjustable in a plane defined by said frame (8b) while maintaining the balance of the at least one user on the at least two saddles/seats (2, 3).

### CROSS-REFERENCE TO RELATED APPLICATIONS

This application is a continuation-in-part of PCT/IB2014/002847 filed on 18 Dec. 2014 and claims priority of Italian Patent Application No. M12013A002174 filed on 20 Dec. 2013, both incorporated herein by reference.

### FIELD OF THE INVENTION

The present invention relates to a velocipede which can be folded or not, and which aims to be very versatile for use, configurable depending on the needs of the user and also having good performance.

### BACKGROUND OF THE INVENTION

It is well known that in recent years cycles have become the subject of great interest and development, as a form of alternative transportation, ecological, comfortable, quick and inexpensive. Their usefulness as tools for training and for the fitness sector has also been emphasized and highly publicized, and seems to be very attractive for the actual economy and of weight in a society tending to do everything possible to maintain physical health, consistent with the time available, that is usually reduced, that everyone has to devote to sports.

The increasing use made of cycles in the city, to avoid traffic, be more independent of the means of transport, both private and public, to enter without problems even areas with restricted traffic, have no parking problems, do a little ‘of daily physical activity even when you do not have time to spend on other things, and be eco-friendly has been a source of further spread of velocipedes, and their increasing diversification in respect of regular bicycles.

In order to meet these needs, an increasing industry of cycles has developed to meet the market demand not fully met and satisfied by the common bicycle. An example of widely diffused cycles, and that seem the best-designed, versatile, widely distributed, are normal velocipedes or those with integrated transmission, or like RUNBIKE, LAURINI, or Q-bike, that are all vehicles well known to the fans of this field.

Considering in this case a vehicle like a Q-bike, as an example of interest belonging to the prior art, what appears advantageous of such a vehicle, is that it is particularly easy to handle, and advantageously is also the average high position of the saddle or seat relatively to the fact of being a front-wheel velocipede, with respect to a medium-low position of the seat usually adopted by the widespread bicycle with front wheel drive. This position allows to maintain an upright posture quite close to the steering axis.

In addition, this position confers to said velocipede a fairly good active and passive visibility, because the elevated position of the driver allows to have a better view on larger road stretches, and therefore permits to identify any obstacles; an elevated position allows even the driver to be more visible from any motorists, this all to the advantage of the safety of the driver of the velocipede, and of the other drivers. Said upright posture also allows to better absorb any impact due for example to a bumpy road surface which, as well known, reflects on the driver. Moreover, even standing starts and the like are facilitated by a more upright posture of the driver.

It is in fact known that, an upright posture of the driver, allows to discharge the large part of the above said impacts on the buttocks and on the pelvis, when these are correctly positioned relative to the vertical position of the body; furthermore impacts are also discharged on the legs, especially in case the sitting position of the user with respect to the pedals facilitates its rise from the seat, unlike what happens instead in the case that the user is in a half-reclining posture. In fact, a posture in which the back is very inclined with respect to the pelvis, or with respect to an axis that is perpendicular to the ground, causes the spine and the pelvis itself to absorb in large part the shock to the detriment of course in the long run of the health of the driver. In addition, a high center of gravity placed close to the drive wheel, will facilitate challenging climbs for the user, thanks to the greater thrust that most drivers are able to exert on the pedals, and because of the proximity of the center of gravity of the vehicle to the drive wheel, which is so not deprived from weights and therefore at risk of slippage.

Furthermore, these cycles are simple to handle, relatively to the size of the components (high center of gravity, and steering axis near the turn of the driver) and require—in certain configurations—a limited maintenance. Additionally, when such vehicles are not provided with a chain to be periodically lubricated, also the risk of getting dirty with the grease of the chain is eliminated, this all to the benefit of the quality of the vehicle.

In addition these vehicles, can be easily stripped, or made foldable with a few tricks, so as to have a particularly compact shape and therefore convenient for transportation.

It seems clear that, said prior art vehicle, in particular a Q-bike type velocipede, has indeed many advantageous aspects, which are due to certain characteristics, including many of those described here above.

Nevertheless, those characteristics that distinguish the Q-bike type vehicle, have also significant negative effects, vitiating and limiting the use of that vehicle.

Some examples of poor performance are the poor stability and still others that will be mentioned here below.

Therefore, the object of the present invention is to provide a velocipede which maintains the positive characteristics that distinguish the above mentioned models of velocipede, but that solves the problems that are associated with this type of vehicles.

In fact, as for any vehicle of this kind, the choice of more or less high positions, the gear mode, etc., includes advantages and disadvantages. In this case, a raised trim as that of a Q-bike, indeed allows to have a greater visibility on the road, but this happens at the detriment of the aerodynamics conferred from an always raised position, and this causes, therefore the speed, and in turn the performance of a vehicle of this kind to be limited, and therefore the advantageous use of the vehicle that could be done is restricted to a certain area, such as use in the city, or climbs, also of demanding type, (which can be much more challenging, as the higher the seat is} but not on wider and faster journey roads, including roads with descents.

Still, a structure of this nature affects the stability of the driver, as a raised center of gravity causes loss of equilibrium and especially road holding. Said lower road holding has in fact problematic aspects especially in the curved sections of the paths, where the centrifugal force due to the speed, which acts particularly in the case of the raised center of gravity, cause considerable instability and loss of grip on the road.

In fact, it has been verified that a high center of gravity, although as mentioned advantageous in several respects, also causes increased risk of tipping during braking, in particular for front wheel drive vehicles, in addition to exposing (for posture held by the driver during pedaling}, the driver himself to the most damaging impacts if falling from the front of the vehicle.

Again it is to be noted that, although the more upright posture and the semi-upright support on the pedals help to absorb better the impacts, it is also true that this trim configuration facilitates, especially in masculine drivers, prostate problems, that is affected by continuous stresses, and also this asset causes cervical stress of the driver during the running phase, that due to the forward folded position of the back, is always directed forward and upward to be able to see the road in a very unnatural posture compared to a correct posture. It seems clear that this has definitely negative effects on the health of the entire spine.

It is to be noted that the document DE 19547050 discloses a velocipede with the front wheel of greater diameter than the rear wheel, which is equipped with a seat that is movable along an axis of development, which corresponds to the one of the handlebar of the bicycle, said seat is adapted to fit to the size of user's leg length, lever arm on the pedals, even changing consistently the geometries overall the vehicle etc. Said velocipede further comprises an innovative steering mechanism but to a person skilled in the art that mechanism seems at least perilous to be used in curve, said vehicle is possibly faired, and still comprises a single seat, adjustable in height by changing its distance, and therefore of the driver, from the axis of the pedals and the drive wheel, without giving the opportunity to maintain the same angle and distance from the pedals in different positions, or alternatively to be driven by the same driver in different positions by maintaining these ratios, nor by more drivers simultaneously.

In addition, W02011/043021 discloses therefore a velocipede acting on the single front wheel, of a monocycle, or double wheel for a velocipede, or multiple for a transport vehicle with rear load, with a known mechanism for multiplying the rotations of the wheel relatively to those of the pedals, possibly provided of a rear cargo area and that can have two different methods of moving the seat or saddle, always a single one, and which cannot allow the same driver to drive the vehicle in different positions while maintaining the same distance from the pedals.

It is finally noted that the DE 102004032027 discloses a velocipede which has the option to move the seat or saddle along the axis of development of the frame of the bicycle, to allow the user to vary its attitude and be used by adults and children, said document substantially discloses a velocipede that can allow a driver to drive the vehicle in more than one mode, maintaining a similar, although not identical, distance from the center of rotation of the pedals, allowing the driver to change partially its position within the asset of the running vehicle, but cannot allow to change said attitude while running, and however without intervening on the geometry of the vehicle, neither may allow two different drivers to act simultaneously in the traction of the vehicle.

### SUMMARY OF THE INVENTION

The present invention provides a vehicle which offers the possibility to the same driver to take depending on the environmental conditions, the most suitable position, i.e. higher and featured with active and passive visibility, simplifying and minimizing the facing of impacts in collisions with bumps or potholes and having good maneuverability in tight and slow, or flatter, being aerodynamic, performing, stable in high speed corners, safe in accidents when moving, which has the advantages that characterize the vehicles of Q-bike type, but that solves the problems of such vehicles, and even more, which is able to enclose in a single vehicle both the advantages of known cycles and the characteristics of versatility and even more efficient use or configurability customized according to the needs and physical characteristics of the user.

An object of the present invention is therefore to realize a velocipede with a good drivability, and ease of handling, without sacrificing stability in cornering.

A further object of the bicycle according to the present invention, it is to be suitable for use both in city environments, outskirts, with faster journey sections, uphill, downhill, etc., where, therefore, the requirements of performance and drive ability are all different.

Another object of the present invention is to provide a vehicle equipped with superior aerodynamics to the standard Q-bike type cycles, without sacrificing any advantages conferred by said type of vehicle.

In particular, an object of this invention is to provide a vehicle that allows to vary the seating of the driver, in a simple and immediate way, keeping a correct and stable center of gravity and distance of the driver from the pedals without having to get down from the same or vary the geometries.

It is therefore an object of the present invention to provide a vehicle that advantageously is provided with a range of driver positions to be chosen, and that therefore allows the driver to adjust or select a preferred position according to the needs to the situation in the most convenient way.

It is accordingly an object of the present invention to reduce the problems of risk of tipping during braking in more aerodynamic positions, ensuring greater stability to the vehicle.

It is still an object of the present invention to disclose a vehicle that is very versatile so as to adapt better to the sitting and posture of the back of the user, both in order to greater convenience and for protecting the health of the user.

It is finally an object of the present invention to describe a vehicle that is easily transportable when not in use, and therefore light, easy to handle and not involving for the user the risk of getting dirty, as well as being possibly foldable to be transported or stored easily in confined spaces.

It is a further object of the present invention to provide a velocipede of extremely compact size, that is usable simultaneously even by two active users.

These and other object described herein, will be achieved thanks to the velocipede according to the present invention, wherein said vehicle is equipped with two or more saddles or seats with variable trim, which enable one or more users to move location or position of the center of gravity of said vehicle to modify the characteristics of use both aerodynamic or not.

It is to be noted in particular that the velocipede according to the present invention has the axis on which the pedals act, coincident with the rotation axis of the front axle.

The velocipede according to the present invention, also concentrates the while transmission system in a more restricted diameter than that of the front wheel, which is inscribed in the circle formed by the pedals, and this allows to have an easily foldable vehicle. Still, compared to common foldable vehicles, for said vehicle it is not necessary to take into consideration the non-compressibility and coaxially of the action on the pedals with respect to that of the wheels—a vehicle of this kind can be compacted into a smaller space and also with greater ease, or using less moves/steps for closing it again, the structure also appears light and therefore easy to carry and handle in case of use in cities, for which said vehicle can be easily loaded onto a common transport means such as train, or even a bus, or the like, or even in the car.

Additionally, in a particularly advantageous way, said vehicle does not require the use of grease to maintain the outer transmission organs lubricated, and this advantageously prevents the user from getting dirty when using the vehicle, or in particular in opening and closing it. There are different types of cycles, just as for example Q-bike, or the vehicle according to the present invention, which operate by dispensing with the central movement placed outside of the hub axle of the wheel, on which pedals are operating, which therefore are equipped with frames of reduced size (one of the reasons for light weight) and reduced pitch, that are also advantageously clean, i.e. do not require grease for lubrication and have a limited need for mechanical maintenance.

Some benefits of simplifying the transmission mechanism are obvious, as the lower weight of the vehicle in the absence of a chain, resulting in fewer problems of breakage of the same, or a fall of the chain.

The velocipede according to the present invention therefore has the purpose of combining in a single vehicle the advantages of a velocipede in which the center of gravity is not particularly set back with respect to the drive shaft, which brings the user to hold a vertical posture, characterized by a good handling and visibility, with the advantages of a vehicle where the user is in a reclined position, with a low center of gravity, which is the ideal position for the descents, and to achieve greater speed.

A considerable advantage and novelty distinguishing the vehicle as specified by the present invention is the configuration of the variable position of the seat of the user, which can be modified even more advantageously also when sitting on the saddle or seat of the bicycle according to the present invention, leveraging on the pedals or even leaning for example on a specially crafted footrest.

A reclined vehicle with low center of gravity, advantageously, creates the conditions wherein the retracted and lowered position of head and body, make said configuration safer, as well as more aerodynamic. In addition to that, for example, also the use of any fairings can help to make the vehicle safer and increase the aerodynamics.

Furthermore, by introducing in said vehicle a joint for the frame, and/or eventually a joint for the handlebars, the vehicle could be an alternative to the normal light and compact folding bikes, and be suitable to the same uses.

Still, for example, in case of reduction of the diameters of the wheels, the weight of the vehicle would further be reduced, by maintaining the possibility to keep more than one seat, all to the benefit of the versatility of the vehicle.

Additionally, as already mentioned, said vehicle will not foul the driver with grease that usually act to maintain smooth the transmission motion, and also the maintenance of the vehicle is particularly simple and inexpensive, (that is given by the simplicity of the components comprising the vehicle that will be described here below) that make it both light and handy and simple to manage, and even more versatile in use.

These and other advantages which characterize the velocipede according to the present invention will be clear from the following detailed description of some preferred embodiments, made with reference to the annexed drawings.

### BRIEF DESCRIPTION OF DRAWINGS

In the drawings,

FIG. 1 shows a Q-bike velocipede known from the prior art,

FIG. 2 shows a preferred embodiment of the velocipede according to the present invention, in which the user is in a possible configuration of usage;

in FIG. 3 it is represented a further preferred embodiment of the vehicle according to the present invention in which the frame has a linear shape;

in FIG. 4 it is represented the same embodiment of the velocipede according to the present invention, wherein said vehicle is used as a tandem;

in FIG. 5 it is shown a further preferred embodiment according to the present invention, in which the shape of the part of frame on which can/may be positioned the one or more seats/saddles is curved;

in FIG. 6a it is shown a preferred embodiment of a double pedal suitable for use in tandem;

in FIGS. 6b and 6c, are shown two different views of a handlebar suitable for use with a vehicle according to one of the embodiments of the present invention; in FIGS. 7a and 7b are represented particularly realistic embodiments of the velocipede according to the present invention; and

FIG. 7c represents a particularly realistic embodiment during use.

### DETAILED DESCRIPTION OF PREFERRED EMBODIMENTS

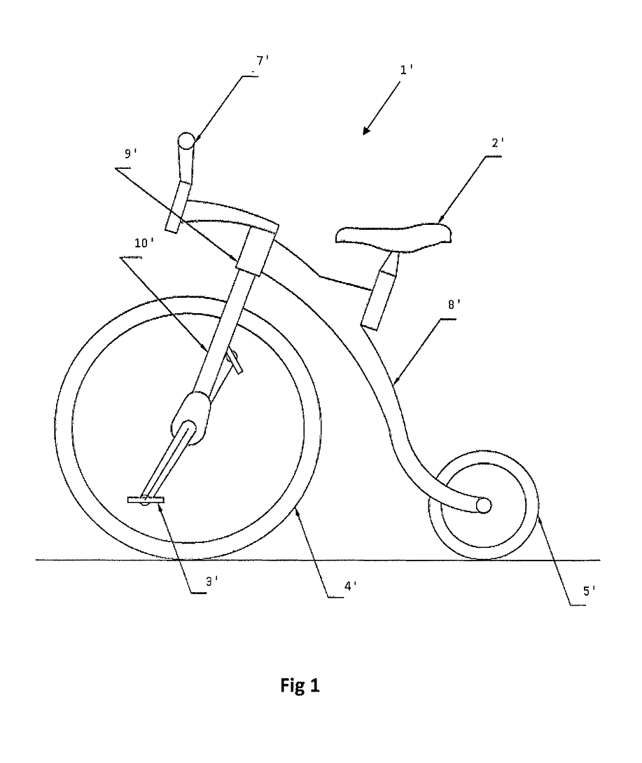

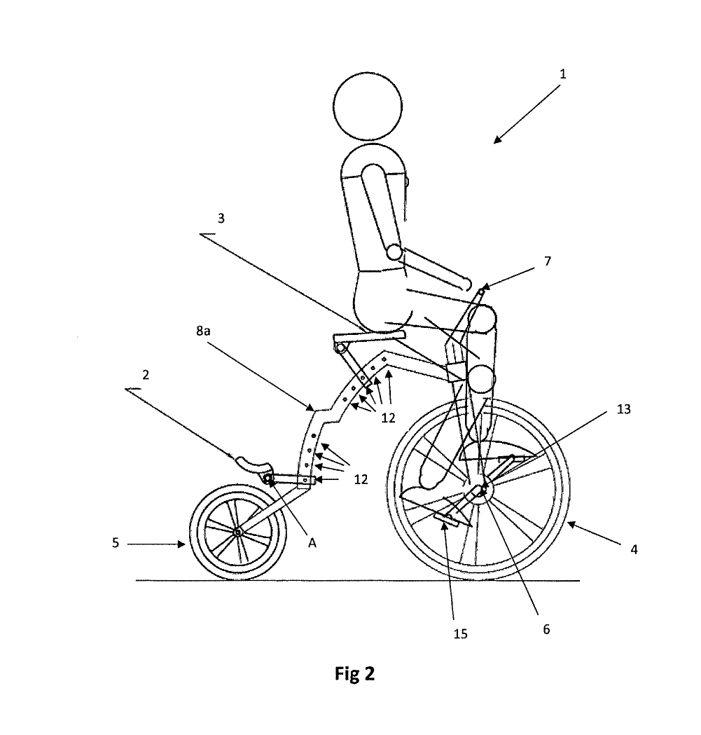

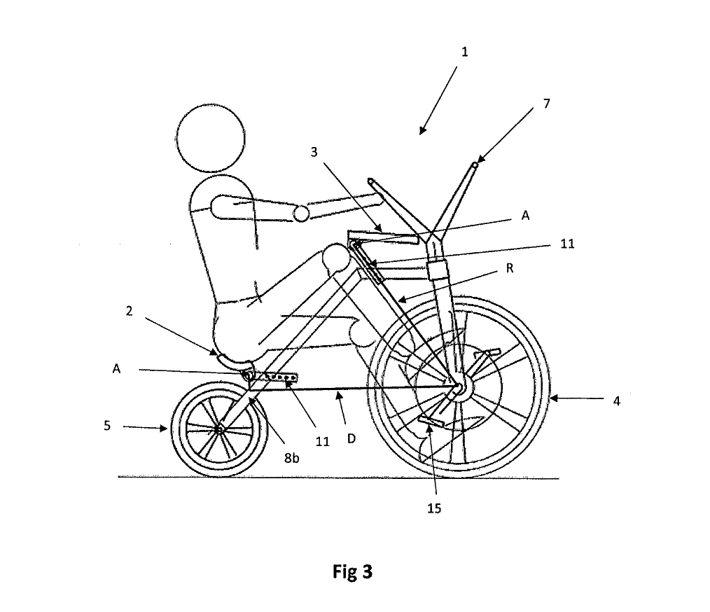

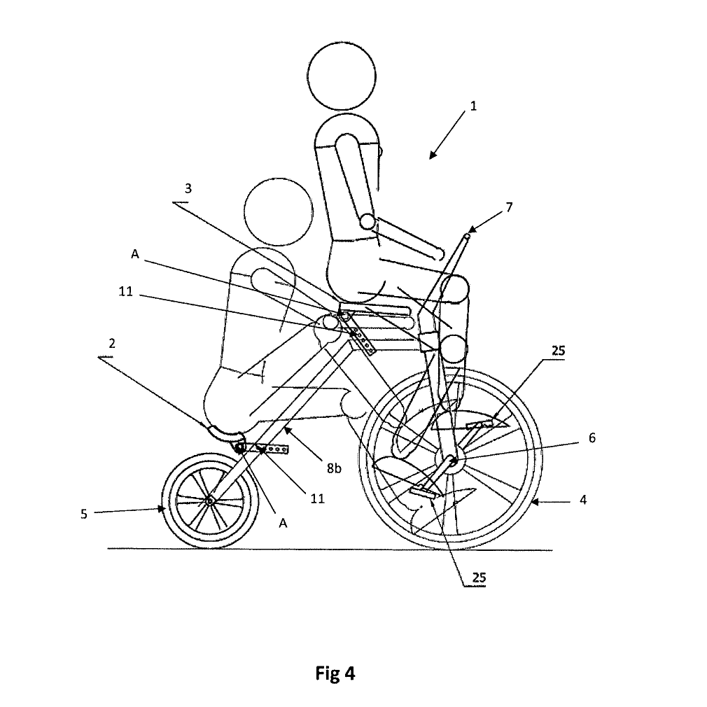

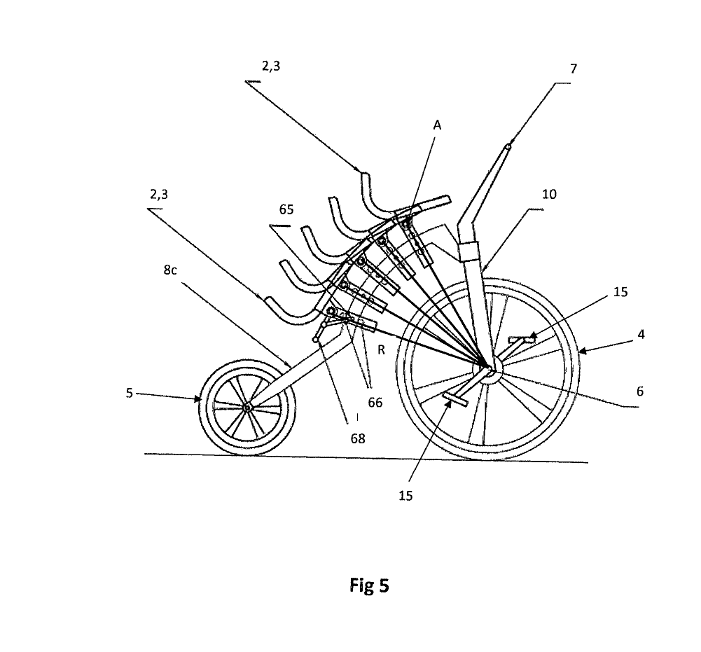

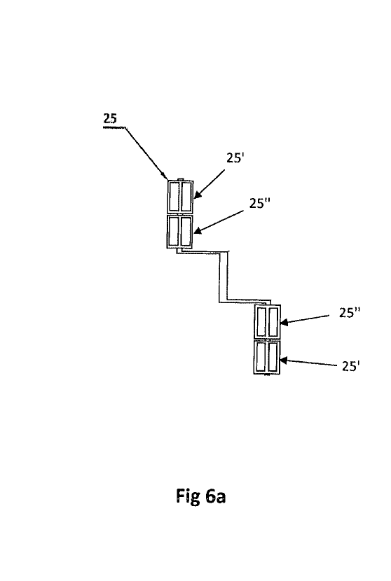

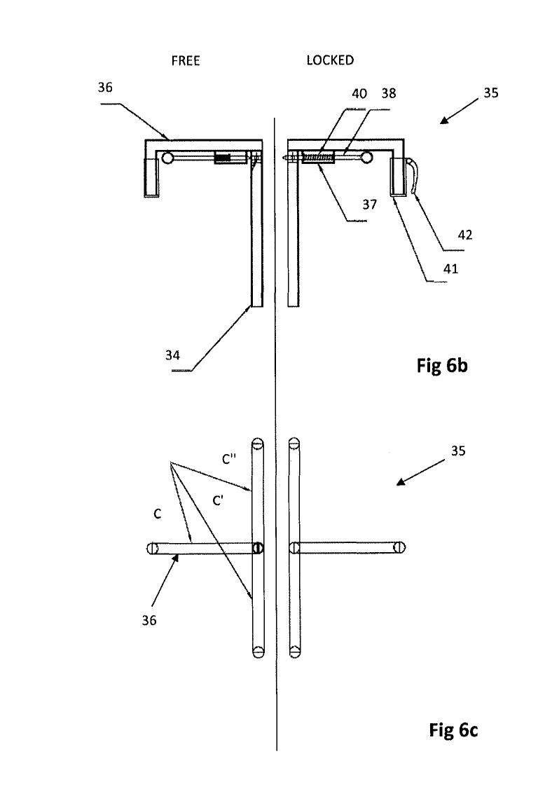

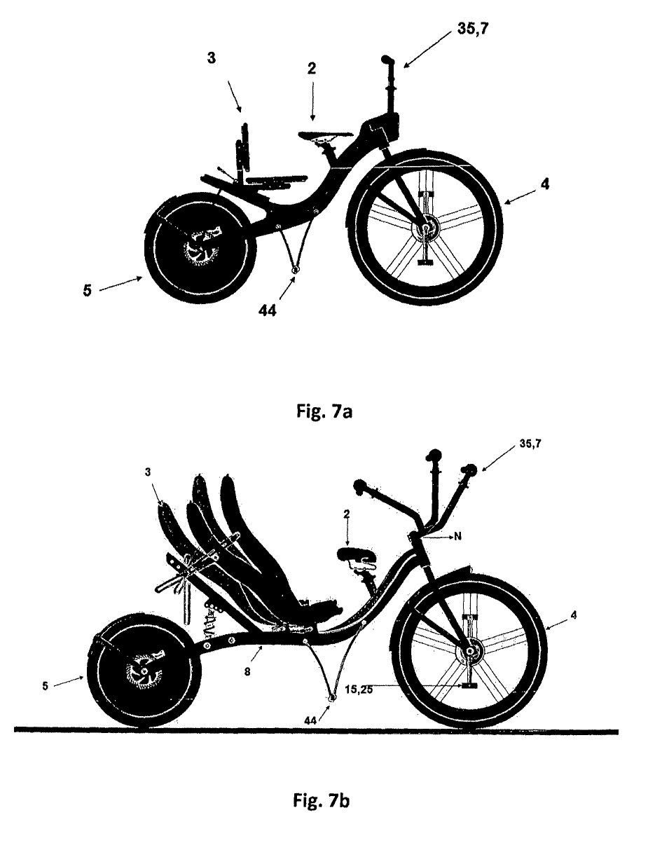

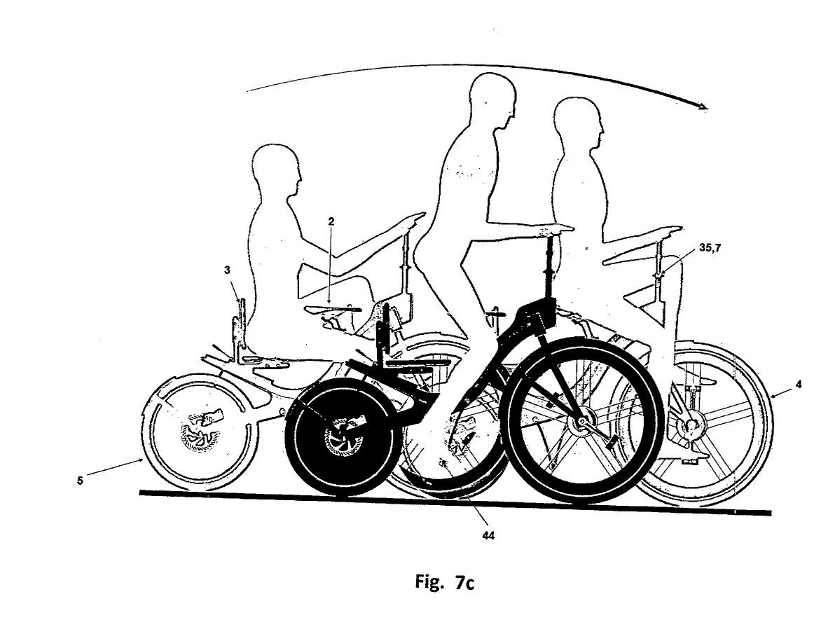

With reference therefore to the Figures, in particular in FIG. 1, a generic vehicle 1′ of the Q-bike type is shown; as mentioned, in the known prior art there are several cycles with seat 2′, with a fixed center of gravity, and the axis of the pedal coincident with that of the hub 13′ of the front wheel, and having transmission systems able to multiply, or possibly gearing down, the rotations of the drive wheel 4′, compared to those of the pedals 3′. There are also other types of vehicle, not shown here, such as the well-known SCHLUMPF or LAURINI, which allow to have a variation in transmission ratios, which are also applicable to vehicles such as the one represented in FIG. 1, which is equipped with a rear wheel 5′, a seat 2′, a handlebar 7′, all connected together by a frame 8′, and a sleeve 9′, through which the handlebar 7′ is connected to the fork 10′, and said fork 10′ therefore connects said elements to the remaining parts of velocipede as described above. With reference to FIGS. 2 to 5, in which are presented some examples of preferred embodiments of the velocipede with adjustable center of gravity of the user and configurable seat; FIG. 2 shows a preferred embodiment of the velocipede according to the present invention, in which the velocipede 1 comprises at least a frame 8a, a front drive wheel 4, a rear wheel 5, at least two saddles or seats 2,3, a pair of pedals 15, a transmission mechanism 6 and a handlebar 7. The user of said velocipede 1, in said preferred embodiment, is advantageously able, as seen in FIG. 2, to change the position or location of the seat/saddle 2 or 3. Both the seat/saddle 2, and the seat/saddle 3 can be positioned along several points in the direction of development of the frame 8a, i.e., in a plane defined by the frame, by means of fixing hooks 12, which allow to vary, independently of one another, reciprocally the position of said saddles/seat 2 or saddle/seats 3. In this case, even more advantageously, the user can decide from time to time to sit on the saddle/seat 2, located in a low center of gravity with respect to the street level, or if to sit on the saddle/seat 3, positioned with the center of gravity raised and closer to the driving wheel 4 with respect to the street level.

It appears immediately clear that, thanks to the pedal axle coinciding with the axis of the hub of the front wheel, and thanks to the shape of the frame 8a, the user can move freely on one or both seats/saddles 2,3, connected to the frame 8a of the velocipede 1, and this while retaining a stable center of gravity. In this case, it is possible to change or adjust, as required, the center of gravity of the user with respect to the street level, and in a particularly advantageous manner, the user can change its position on the velocipede without getting off the velocipede 1 itself. In fact it is sufficient that the user rests his feet on the ground, or on special alternative means of support, described in the Figures below, or, when possible, to point the feet on the pedals, for moving the seat position from the front to the rear, and so to change the barycentric trim on velocipede 1, without losing the balance in each case. Additionally, in a particularly advantageous way, the seat/saddle 2, 3 may have a variable inclination (rotation fulcrum A), to better match the physical characteristics of the user.

Moreover, those seats/saddles 2,3, in a particularly advantageous manner, can be adjusted slidably on the axis of the frame, for example through affixed hooks, in a variable number of one or more adjustment positions 9, which in the preferred embodiment here represented only as an example, are four for each seat/saddle 2, 3.

In FIGS. 3 and 4, it is represented a further preferred embodiment of the present invention, in which the frame 8b of the velocipede according to the present invention has a linear shape. In said embodiment there are shown in each case two seats/saddles 2 and 3, usable, as seeing clearly from FIG. 2, by a single user to vary the position on the velocipede 1, for example, in case said user would like to have a lowered center of gravity, to facilitate the downhill speed and have greater cornering stability, and moreover, said user can choose the position for example on the seat/saddle 3, that is closer to the front wheel, and have greater visibility on the road, has an attitude that permits to better discharge the road backlashes and discharge the back for compensating the impacts due to the movement, that correlated with the further advantages already described hereinbefore.

In any case, in this embodiment of FIGS. 3 and 4, the user always maintains a position with good stability on the vehicle, and said vehicle is composed as is evident, by elements that keep it light and handy, which is a decidedly innovative and advantageous in respect of the cycles of the prior art . As evident and further advantageous in it is to notice that in each embodiment of the present invention, observing also the handlebar 7, said velocipede is a vehicle in which all the limbs actively contribute in producing the motion or in directing the vehicle, without the steering being obtained by commands acting on levers, cables or other instruments, but directly by matching the rotation of the steering axis angle of the limbs with respect to the axial position of the seat and linear motion. Even more advantageously, as represented in FIG. 4, said velocipede 1 can be used as tandem, thanks to the simple insertion of a double freely orientable pedal 25, visible in more detail in FIG. 6a, in which there are clearly identifiable two supports 25′ and 25″ for the simultaneous positioning of a pair of right/left feet of two users, acting by rotating the pedal 25 around the transmission with a central movement, acting both users simultaneously on said double pedal 25. It is clear in any case that the double pedal 25 is adapted to be used by a single user, without losing any characteristic performance.

In this case, the hands of the user who is sitting on the back saddle/or seat 2, can hold up to suitable supports not shown here.

In the case shown here, as in the case of FIG. 3, in which there is only one user, the seats/saddles 2 and 3 can be rotatably adjusted about a pivot A, because the inclination of the pelvis is more convenient to the user. To adjust for having the right distance of the bust from the pedals 15, said saddles or seats 2,3 can be adjusted as follows: the seat/saddle 2, can be set through appropriate hooks or pins 11, or other elements suitable for the purpose, horizontally with respect to a distance D of the pelvis from the pedals; and the seat/saddle 3, can be adjusted by, for example through fixation pins 11, radially in the direction R with respect to the center of the transmission of the motion 6, which is also the center of the drive wheel 4.

With particular reference now to FIG. 5, the frame 8c of this preferred embodiment of the velocipede 1 is curve shaped, and note further that, although it is not shown here, it appears evident that, in a particularly advantageous way, said type of frame 8c described in the present invention, is suitable for use with wheels of varying diameter, and also with front and rear wheels of equal diameter, and as it is immediately evident to an expert of the field, this can be done only applying small changes to the frame 8c of the velocipede 1 according to the present invention.

Again, as shown in the preferred embodiment of FIG. 5, it is also possible to obtain a velocipede 1, equipped with a seat I saddle 2 or 3, controlled by a command engagement/release 68, which acts on the fixing hooks 65, connected to holes 66 provided with bearings 69. Note that the said hooks 65, and holes 66 have bearings 69, may be of any shape and adjusted in many widely ways known, which therefore will not be specified here, but are still the subject of the present invention. In FIG. 5, thus it is clearly represented a single seat/saddle 2 or 3, adjustable, as said, in a position sliding on the frame B, and rotatable about a pivot A, for the proper and convenient positioning of the pelvis of the user, and further adjustable along a radial distance R from the center of the transmission 6 of the motion.

In FIGS. 6a, 6b, and 6c there are also represented further possible advantageous characteristics to implement the velocipede 1 according to the present invention; in FIG. 6a an embodiment of a possible double pedal suitable for use in tandem is shown, particularly convenient because it allows both users to act simultaneously on the pedal, or to a single user to choose the most appropriate alignment of the feet. In FIG. 6b is shown an adjustable handlebar 35 which can be mounted on each velocipede 1 according to the present invention. Said orientable handlebar 35, is provided in FIGS. 6b and 6c with a base 34 and an arm 36, and said arm 36 can be fixed in three positions, to be gripped with the hands, namely C, C′, C″ by interlocking of a retainer 38 in the holes 39. Pulling said retainer 38, thanks to the plug and release action of the spring 37 in the housing 40, said handlebar 35 can be oriented in three different positions. Furthermore, said handlebar is provided with a pair knobs 41, a brake 42 which simplifies steering. FIG. 6C shows a top view of the above said three positions which the adjustable handlebar 35 can take to further clarify the operation of the mechanism.

FIG. 7a is representing a possible embodiment of the velocipede 1 according to the present invention in a particularly realistic way, which corresponds to a prototype realized by the applicant, and which includes all the innovative features described so far, in some particular advantageous embodiments, such as seat or saddles 2,3 shaped in a particularly ergonomic and comfortable manner, even equipped with a backrest, which could be also foldable, a handlebar 7,35 with the tilt angle advantageously variable with respect to the driver of the velocipede, and even a footrest 44, comprising lateral supports , particularly suited to the support of the feet of a user, when said user desires to move from one to another seat during the running session, said footrest is suitable also to facilitate this step, also in case of a possibly at least third intermediate position.—as shown in FIG. 7c. Again said footrest 44, that is also visible in the variant of FIG. 7b, which as here earlier mentioned in the description of the other Figures, is one of the possible embodiments, is further possibly adjustable, foldable, able to return to the highest position on command, equipped with springs, able to facilitate in a more convenient way the passage between positions even for little athletic users without need to get off from said velocipede 1. Please note that as it may be obvious, there may be one or more footrests 44, depending on the needs or embodiments, said footrests can also be realized lockable or removable from the vehicle, and obviously tilted and fastened to the frame 8 of said velocipede in any way suitable for the purpose. Said at least one or more footrests 44 are therefore adapted to facilitate the passage in motion of the user between two or more driving positions or to make more comfortable the disengagement of the leg of the rear driver, or passively support the lower limbs for the passive transport of a passenger in the rear position; alternatively it would obviously by possible to rest the feet on the ground by stopping the vehicle, or using the pedals as a lever, however, it seems clear that the solution of the footrests is facilitating and comfortable, and permits advantageously to avoid stopping the vehicle even to a not experienced driver or to a not particularly agile one.

In FIGS. 7a and 7b there are well visibly represented further variants of saddles/seats, which are of course only some of the possible embodiments, and more, the handlebar particularly represented in FIG. 7b, may include, for example, with a command actuated from the handlebar, a stop for the handlebar 7,35 to rotate it in two or more positions around a center of rotation N, this is always to the advantage of the plurality of positions taken by the driver of the vehicle and also to the advantage of the possibility of changing in the most appropriate and convenient way for said user the inclination of said handlebar 35,7. In FIG. 7c it is represented the same sequence of the movement of the driver, in a realistic version, as described for FIGS. 7a and 7b.

These are just some of the preferred embodiments of the velocipede with variable trim according to the present invention, it is to be noted that any velocipede with front-wheel drive, with at least two wheels, realized with any diameter, suitable to mount a gear on the hub of the drive wheel, and having a frame form suitable to mount more saddles/seats with adjustable positioning, both rotatably around a center of rotation and translatably along the frame structure, which is also adjustable on an saddle carrying axis, bound to said frame, in a radial direction relative to a center placed corresponding to the hub of the drive wheel, are object of the present invention. In any case, whatever velocipede with front-wheel drive, though modified, which has more than one seat with variable trim, obtained without changing the geometry of the frame and its trail, which allows to vary the center of gravity of one or more users, with respect to the velocipede, even considering the above variants of the shape of the frame, the diameter of the wheels, handlebars and/or other elements, is to be considered object of the present invention, without that said variants modifies the field of protection of the present invention; as well as said velocipede and the constituent elements, can be realized in any material suitable for the purpose, and may present alternative embodiments with respect to those preferred previously described, in which modifications and changes concerning for example the geometry chosen for the individual movable and fixed elements, the materials adopted for each organ, and also the specifications of the various systems of displacement of the saddles/seats, as well as the mechanisms acting on the vehicle, may be made without departing from the scope of protection of the present invention as defined in the annexed claims.

1. A velocipede (1) with front wheel drive, comprising at least one front wheel (4), with pedal axis (15) coincident with front hub axle (13) of said front wheel (4), a frame (8), a fork (10) and at least one saddle (2,3), a transmission mechanism (6), a handlebar (7), and rear wheel (5), characterized in that location of the center of gravity of at least one user of said velocipede (1) is adjustable in a plane defined by the frame while maintaining stability of said at least one user, in at least two positions on at least two spaced saddles (2) or (3) mounted to frame (8a, 8b, 8c), one saddle (3) is adjustable at least along a radial axis (R), defined by distance between the hub axle (13) and fulcrum of rotation (A) of the saddle seat, by adjusting means (11), and at least one additional saddle is adjustable along an axis (D), defined by distance between said fulcrum of rotation (A) of the additional saddle and the hub axle (13), by adjustment means (11) for optimizing stability, aerodynamics and comfort of the driver with respect to the driving conditions.

2. The velocipede (1) according to claim 1, wherein said velocipede (1) comprising said frame (8b) is suitable to accommodate two active users simultaneously, respectively on said one saddle and on at least one additional saddle.

3. The velocipede (1), according to claim 1, wherein said transmission mechanism (6) is coincident with the axle hub (13).

4. The velocipede (1) according to claim 1, wherein said velocipede (1) comprises a pair of pedals (25) equipped with double support for two pairs of feet having rotation axis coincident with the hub axle (13).

5. The velocipede (1) according to claim 1, wherein said at least one saddle is adjustable along the frame (8a,8c).

6. The velocipede (1) according to claim 1, wherein said velocipede (1) is equipped with a linear (8a) or a curved frame (8c) or in the form of step (8b) or other form, suitable for a variation of configuration of the center of gravity of said user of said velocipede (1).

7. The velocipede (1) according to claim 1, wherein said velocipede (1) has at least one rear wheel (5) of diameter no greater than the front wheel (4).

8. The velocipede (1) according to claim 1, wherein said handlebar (7) is an adjustable handlebar (35) having at least three positions (C, C′, C″) of orientation for the grip of the hands on said adjustable handlebar (35).

9. The velocipede (1) according to claim 1, wherein said velocipede (1) is equipped with at least one footrest (44) for foot support of one or more user of said velocipede.

10. The velocipede (1) according to claim 9, wherein said at least one footrest (44) is adapted to facilitate the passage in motion of the user between two or more positions of the driving attitude or for making more comfortable disengagement from velocipede pedals (25), or passively supporting the lower limbs for passive transport of a passenger rear position.
